(19) United States
(12) Patent Application Publication
(10) Pub. No.: US 2008/0007877 A1
(43) Pub. Date: Jan. 10, 2008

(54) Magneto-resistance effect element, magnetic head, magnetic recording/reproducing device and magnetic memory

(75) Inventors: Masahiro Takashita, Yokohama-shi (JP); Masayuki Takagishi, Tokyo (JP); Hitoshi Iwasaki, Yokosuka-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/709,795

(22) Filed: Feb. 23, 2007

(30) Foreign Application Priority Data
Jul. 7, 2006 (JP) P2006-188709

(51) Int. Cl. G11B 5/127

(52) U.S. Cl. 360/324.12

(57) ABSTRACT

A CPP type magneto-resistance effect element includes a magneto-resistance effect film with a fixed magnetization layer, a free magnetization layer and a non-magnetic intermediate layer; and a perpendicular biasing mechanism configured to apply a perpendicular biasing magnetic field to the free magnetization layer under the condition that the biasing magnetic field is parallel to a main surface of the magneto-resistance effect film and perpendicular to the magnetization of the fixed magnetization layer. Then, the magneto-resistance effect element satisfies the relation of 1.2≦MRH/MRT when the width parallel to the perpendicular biasing magnetic field is defined as MRT and the width orthogonal to the perpendicular biasing magnetic field and parallel to a signal magnetic field.

### CROSS-REFERENCE TO THE INVENTION

This application is based upon and claims the benefit of priority from the prior Japanese Patent Application No. 2006-188709, filed on Jul. 7, 2006; the entire contents of which are incorporated herein by reference.

### BACKGROUND OF THE INVENTION

1. Field of the Invention

The present invention relates to a magneto-resistance effect element which is configured such that a current is flowed in the direction perpendicular to the film surface thereof, a magnetic head, a magnetic recording/reproducing device and a magnetic memory which include the magneto-resistance effect element, respectively.

2. Description of the Related Art

GMR (Giant Magnetoresitive Effect) heads with GMR elements representing GMR effect are widely utilized in reproducing the intended information from magnetic recording media in magnetic recording/reproducing devices such as hard disks.

As the GMR element can be exemplified a spin valve type magneto-resistance effect element wherein a fixed magnetization layer with a magnetic film of which the magnetization is substantially fixed in one direction, an intermediate layer and a free magnetization layer with a magnetic film sensitive to (rotatable to) an external magnetic field (which is, e.g., a signal magnetic field from a magnetic recording medium, and the magnetization is normally set to parallel or anti-parallel to the magnetization of the fixed magnetization layer) are subsequently stacked. The magnetization of the fixed magnetization layer is fixed by an antiferromagentic film or the like.

In order to avoid Barkhausen noise, a perpendicular biasing mechanism (e.g., magnetic domain controlling films preferably made of cobalt-platinum alloy or cobalt-chromium-platinum alloy film) is employed for the GMR element so that a perpendicular biasing magnetic field is applied to the free magnetization layer of the GMR element. In this case, the perpendicular biasing magnetic field is also applied almost in parallel to the main surface of the magneto-resistance effect film so as to be perpendicular to the magnetization of the fixed magnetization layer. Therefore, the magnetization direction of the fixed magnetization layer is almost perpendicular to the magnetization direction of the free magnetization layer under no signal magnetic field condition.

The GMR effect occurs from the relative angular variation between the magnetizations of the fixed magnetization layer and the free magnetization layer.

CIP (Current In Plane)-GMR elements are configured such that the intended magneto-resistance effects can be detected by flowing sense currents so as to be parallel to the laminated structures of the elements, respectively.

Recently, TMR (Tunnel Magnetoresistive) heads with TMR elements are researched and developed, wherein the intermediate layers are made of insulator such as aluminum oxide and sense currents are flowed perpendicular to the laminated structures of the TMR elements to detect the magneto-resistance effects thereof so as to enhance the recording densities thereof, respectively. Such a TMR head can enhance the magneto-resistance effect. But since the intermediate layer is made of the insulator, it also enhances the preamplifier noise and the shot noise which is inherent to a device wherein a current is flowed through the insulator.

Then, CPP (Current Perpendicular to Plane)-GMR elements are also researched and developed, wherein sense current is flowed perpendicular to the main surface of the laminated structures of the elements to detect the magneto-resistance effects thereof. The CPP-GMR element can realize a higher recording density than the CIP-GMR element because the CPP-GMR element can generate higher reproducing signals in comparison with the CIP-GMR element even though the track width is narrowed.

With the CIP-GMR element, since a sense current is flowed along the main surface of the laminated structure thereof, a portion to represent magneto-resistance effect is narrowed as the recording track width is narrowed, so that the resistance variation amount AR is decreased. With the CPP-GMR element, in contrast, since a sense current is flowed perpendicular to the stacking direction of the laminated structure thereof, the resistance variation amount AR is not quite decreased even though the recording track width is narrowed. Also, with the CPP-GMR element, since an insulator is not employed as an electric conductor as the TMR element, the element resistance can be lowered in comparison with the TMR element.

On the other hand, with the recent high density recording requirement, the GMR element is being downsized in the track width direction and height direction. In such a downsized CPP-GMR element, a phenomenon called as “current induced magnetization switching (spin transfer)” may occur.

Under the current induced magnetization switching, the magnetization direction of the free magnetization layer is caused almost parallel to the magnetization direction of the fixed magnetization direction when a sense current is flowed to the fixed magnetization layer from the free magnetization layer. On the other hand, the magnetization direction of the free magnetization layer is substantially varied so that the magnetization direction of the fixed magnetization layer is caused almost anti-parallel to the magnetization direction of the free magnetization direction when a sense current is flowed to the free magnetization layer from the fixed magnetization layer. As a result, under the current induced magnetization switching, the magnetic response of the free magnetization, that is, the resistance variation amount AR of the CPP-GMR element may be lowered or diminished.

The current induced magnetization switching may occur frequently in an element with a track width or height length of 100 nm or below wherein the magnetic domain in the magnetic layer is likely to be single domain so that the disadvantage of edge domain can be reduced. In the recent magnetic recording device and magnetic reproducing device, it is required that the track width and the height length are set to 100 nm or below. In view of high density recording, therefore, it is required to fabricate the CPP-GMR element with reduced current induced magnetization switching.

Recently, in contrast, it is proposed that the current induced magnetization switching under a perpendicular biasing magnetic field can be reduced by appropriately controlling the sense current direction and the biasing point. However, since the control of the biasing point is complicated, the biasing point may fluctuate per element, so that the productive yield of element is lowered. In this point of view, it is desired that the current induced magnetization switching can be reduced irrespective of biasing point so that the biasing point of the element can be obtained as designed initially, and thus, the intended magneto-resistance effect element can be obtained under high and stable productive yield.

### SUMMARY OF THE INVENTION

It is an object of the present invention to reduce in order to fabricate an intended magneto-resistance effect element under high and stable productive yield. It is another object of the present invention to provide a magnetic head, a magnetic recording/reproducing device and a magnetic random access memory which utilize the magneto-resistance effect element.

In order to achieve the above objects, an aspect of the present invention relates to a magneto-resistance effect element, comprises a magneto-resistance effect film including a fixed magnetization layer of which a magnetization direction is fixed in one direction, a free magnetization layer of which a magnetization direction is varied in accordance with a signal magnetic field from a magnetic recording medium, and a non-magnetic intermediate layer representing metallic conduction which is provided between the free magnetization layer and the fixed magnetization layer; a perpendicular biasing mechanism configured to apply a perpendicular biasing magnetic field to the free magnetization layer under the condition that the biasing magnetic field is parallel to a plane of the magneto-resistance effect film and perpendicular to the magnetization of the fixed magnetization layer; and a pair of electrodes electrically connected to the magneto-resistance effect film so as to apply a current, flown from the fixed magnetization layer to the free magnetization layer; wherein the relation of 1.2≦MRH/MRT is satisfied when in the free magnetization layer, in which MRT is a width being parallel to the perpendicular biasing magnetic field, and MRH is width being orthogonal to the perpendicular biasing magnetic field and being parallel to the signal magnetic field from the magnetic recording medium.

Another aspect of the present invention relates to a magnetic head including the magneto-resistance effect element.

Still another aspect of the present invention relates to a magnetic recording/reproducing device including the magnetic device and a magnetic recording medium.

A further aspect of the present invention relates to a magnetic memory including the magnetic head.

The inventors have intensely studied to achieve the above objects. As a result, they found out the following fact of matter. Although the current induced magnetization switching under a perpendicular biasing magnetic field is varied remarkably in dependence on the biasing point, the current induced magnetization switching can be reduced as the value of MRH/MRT is increased. Particularly, if the value of MRH/MRT is set to 1.2 or over, the current induced magnetization switching is not almost dependent on the biasing point. According to the magneto-resistance effect element of the present invention, the spin injecting magnetization reverse can be reduced not in dependence on the biasing point. Therefore, the productive yield of the magneto-resistance effect element can be enhanced.

As described above, it is required that the MRH and MRT of the magneto-resistance effect element are set to 100 nm or below so as to realize the high density recording. In this case, the magneto-resistance effect element becomes difficult in fabrication due to the minute components originated from the minute MRH and MRT, and particularly, it is difficult that the MRH is downsized to 100 nm or below. According to the magneto-resistance effect element of the present invention, however, since it is required that the MRH is set longer than the MRT, the intended magneto-resistance effect element with the minute components can be also fabricated at high productive yield.

According to the prospect of the inventors, if the magneto-resistance effect element is downsized, it may be that the current induced magnetization switching is likely to occur because the edge domain is not generated. In real, according to the research and development of the inventors, if the MRH and MRT of the magneto-resistance effect element are set to 100 nm or above under no perpendicular biasing magnetic field, the current induced magnetization switching is not likely to occur as the prospect of the inventors. In the case that the MRH and MRT of the magneto-resistance effect element are set to 100 nm or below, if the perpendicular biasing magnetic mechanism is provided and the value of MRH/MRT is increased, concretely to 1.2 or over, according to the present invention, the spin injecting magnetization reverse of the magneto-resistance effect element can be reduced.

Conventionally, it was generally considered that the value of MRH/MRT is set to 1 or below. The magnetic field from a magnetic recording medium becomes larger at the opposing side of the magneto-resistance effect element to the medium, and becomes smaller toward the MRH direction due to the top shield layer and the bottom shield layer. In this point of view, the MRH is generally set to a smaller value. Then, if the value of MRH/MRT is set to not less than one, the perpendicular biasing magnetic field can not be applied sufficiently because the antimagnetic field coefficient in the MRT direction is larger than the one in the MRH direction. In the present invention, however, it becomes apparent that the current induced magnetization switching can be reduced when the value of MRH/MRT is set to a larger value. In this point of view, the present invention breaks down the above-described conventional technical consideration.

Herein, the documents Nos. 1 to 4 as listed below teach a similar technique to the present invention, but are directed at a CIP type magneto-resistance effect element. In contrast, the present invention is directed at a CPP type magneto-resistance effect element because the current is flowed to the free magnetization layer from the fixed magnetization layer in the stacking direction. Therefore, the cited documents and the present invention are directed at a similar magneto-resistance effect element, but can not be diverted to one another because the principles of the CIP type magneto-resistance effect element and the CPP type magneto-resistance effect element are different from one another as described in “Related Art”. Then, it is apparently understood by the person skilled in the art that the CIP type magneto-resistance effect element is quite different from the CPP type magneto-resistance effect element. As a result, it is apparent that the technical components of the CIP type magneto-resistance effect element can not be diverted to the technical components of the CPP type magneto-resistance effect element.

Moreover, in the CIP type magneto-resistance effect element, the current induced magnetization switching can not occur inherently, so that there is no motivation to divert the technique of the CIP type magneto-resistance effect element to the CPP type magneto-resistance effect element according to the present invention.

[Document No. 1] JP-A 2002-208120 (KOKAI)

[Document No. 2] JP-A 2000-137906 (KOKAI)

[Document No. 3] U.S. Pat. No. 6,338,899 B1

[Document No. 4] US 2004/0121185 A1

In one embodiment, the relation of 1.2≦MRH/MRT≦2.5 is satisfied for the width MRT parallel to the perpendicular biasing magnetic field and the width MRH orthogonal to the perpendicular biasing magnetic field and parallel to the signal magnetic field from the magnetic recording medium in the free magnetization layer. If the value of MRH/MRT is set too high, the demagnetizing field in the MRT direction of the magneto-resistance effect element is also increased too high so that the perpendicular bias magnetic field can not be applied to the free magnetization layer sufficiently. However, if the relation of MRH/MRT≦2.5 is satisfied, the above-described problem can not be caused.

In another embodiment, the current is a sense current so as to be flowed to the free magnetization layer from the fixed magnetization layer. In this case, the ratio of electron with spin to invert the magnetization of the free magnetization layer and thus, cause the current induced magnetization switching can be reduced. Therefore, the current induced magnetization switching can be inhibited effectively in the magneto-resistance effect element.

According to the present invention, an intended magneto-resistance effect element can be provided at high and stable productive yield under the reduction of the current induced magnetization switching. Then, a magnetic head, a magnetic recording/reproducing device and a magnetic random access memory which utilize the magneto-resistance effect element can be provided.

### BRIEF DESCRIPTION OF THE DRAWINGS

FIG. 1 is a cross sectional view illustrating an embodiment of the magneto-resistance effect element of the present invention.

FIG. 2 is a schematic view illustrating the width MRT which is almost parallel to a perpendicular biasing magnetic field and the width MRH which is almost orthogonal to the perpendicular biasing magnetic field and almost parallel to a signal magnetic field in the free magnetization layer of the magneto-resistance effect element according to the present invention.

FIG. 3 is a cross sectional view illustrating another embodiment of the magneto-resistance effect element of the present invention.

FIG. 4 is a cross sectional view illustrating still another embodiment of the magneto-resistance effect element of the present invention.

FIG. 5 is an explanatory view showing one step in the fabrication of the magneto-resistance effect element illustrated in FIG. 1.

FIG. 6 is also an explanatory view showing one step in the fabrication of the magneto-resistance effect element illustrated in FIG. 1.

FIG. 7 is an explanatory view for the bias point in the magneto-resistance effect element of the present invention.

FIG. 8 is a perspective view illustrating the schematic structure of a magnetic recording/reproducing device according to the present invention through the representation of the essential components.

FIG. 9 is an enlarged perspective view illustrating a portion of the magnetic head assembly positioned at the tip side thereof from the actuator arm of the magnetic recording/reproducing device illustrated in FIG. 8, as viewed from the side of the magnetic recording medium.

FIG. 10 is a graph showing the relation between the magneto-resistance ratio and the bias point of the magneto-resistance effect element according to the present invention when a sense current is flowed to the fixed magnetization layer from the free magnetization layer of the magneto-resistance effect element.

FIG. 11 is also a graph showing the relation between the magneto-resistance ratio and the bias point of the magneto-resistance effect element according to the present invention when a sense current is flowed to the fixed magnetization layer from the free magnetization layer of the magneto-resistance effect element.

FIG. 12 is also a graph showing the relation between the magneto-resistance ratio and the bias point of the magneto-resistance effect element according to the present invention when a sense current is flowed to the fixed magnetization layer from the free magnetization layer of the magneto-resistance effect element.

FIG. 13 is also a graph showing the relation between the magneto-resistance ratio and the bias point of the magneto-resistance effect element according to the present invention when a sense current is flowed to the fixed magnetization layer from the free magnetization layer of the magneto-resistance effect element.

FIG. 14 is a graph showing the relation between the magneto-resistance and the signal magnetic field in the magneto-resistance effect element according to the present invention when a sense current is flowed to the fixed magnetization layer from the free magnetization layer of the magneto-resistance effect element.

FIG. 15 is also a graph showing the relation between the magneto-resistance and the signal magnetic field in the magneto-resistance effect element according to the present invention when a sense current is flowed to the fixed magnetization layer from the free magnetization layer of the magneto-resistance effect element.

FIG. 16 is also a graph showing the relation between the magneto-resistance and the signal magnetic field in the magneto-resistance effect element according to the present invention when a sense current is flowed to the fixed magnetization layer from the free magnetization layer of the magneto-resistance effect element.

### DESCRIPTION OF THE EMBODIMENTS

Hereinafter, the present invention will be described in detail with reference to the drawings.

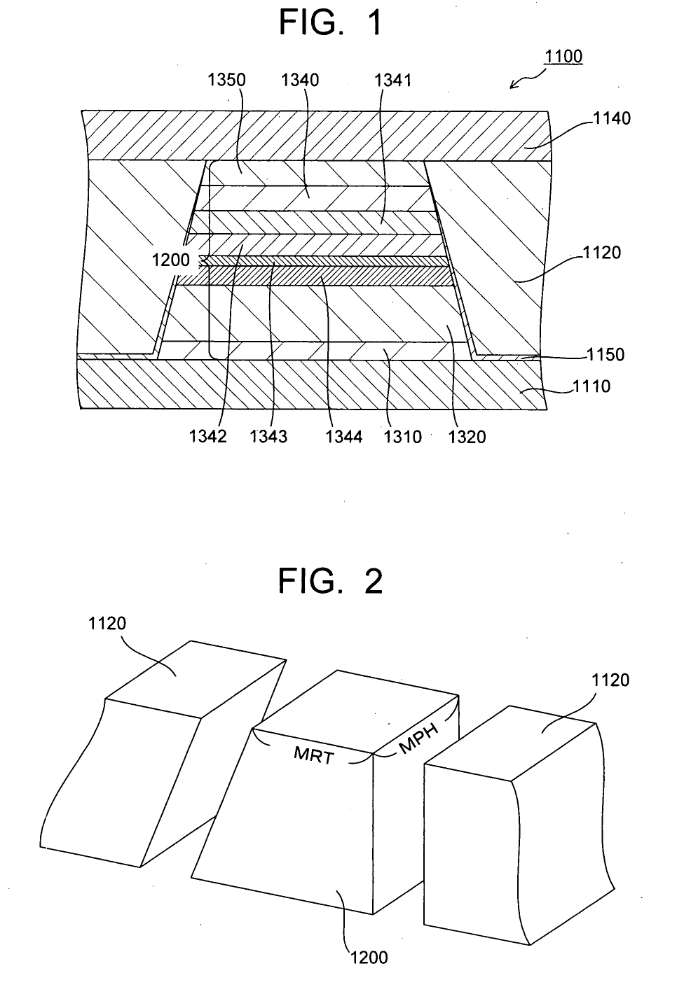

FIG. 1 is a cross sectional view illustrating an embodiment of the magneto-resistance effect element of the present invention. In FIG. 1, the cross section of the magneto-resistance effect element is viewed from the magnetic recording medium-opposing surface thereof. The information of the magnetic recording medium is read out by the magneto-resistance effect element as described above. The magneto-resistance effect element 1100 constitutes a CPP (Current Perpendicular to Plane) type magneto-resistance effect element so as to include a spin valve film 1200 made of a multilayered film, a pair of magnetic domain controlling films 1120 which are provided at both sides of the spin valve film 1200 in the recording track direction, and a top shield layer 1110 and a bottom shield layer 1140 which are provided so as to sandwich the magnetic domain controlling film 1120 and the spin valve film 1200 in the stacking direction thereof.

The magnetic domain controlling films 1120 are connected to the spin valve film 1200 via insulating layers 1150. The spin valve film 1120 includes an underlayer 1310, an antiferromagnetic layer 1320, a ferromagnetic layer 1344, a magnetic coupling layer 1343, a fixed magnetization layer 1342, an intermediate layer 1341, a free magnetization layer 1340 and a protective layer 1350 which are subsequently stacked on the bottom shield layer 1110.

In this embodiment, the magnetization of the fixed magnetization layer 1342 is oriented perpendicular to the space of the present specification, and a perpendicular bias magnetic field is applied to the free magnetization layer 1340 at both sides thereof originated from the magnetic domain controlling films 1120 so as to be almost parallel to the main surface of each layer contained in the magneto-resistance effect element 1100. In this embodiment, therefore, the width MRT almost parallel to the perpendicular bias magnetic field and the width MRH almost orthogonal to the perpendicular biasing magnetic field and almost parallel to a signal magnetic field from the magnetic recording medium in the free magnetization layer 1340 correspond to the width and the depth of the free magnetization layer 1340 as schematically depicted in FIG. 2, respectively.

In this embodiment, the relation of MRH/MRT≧1.2 is satisfied. In this case, even though the MRT and MRH are set to not more than 100 nm, the spin injecting magnetization inverse does not almost depend on the bias point, so that the productive yield of the magneto-resistance effect element 1100 can be enhanced. Preferably, the relation of MRH/MRT≧1.5 is satisfied.

In this embodiment, it is desired that the relation of 1.2≦MRH/MRT≦2.5 is satisfied. If the value of MRH/MRT is set too high, the demagnetizing field in the MRT direction of the magneto-resistance effect element 1100 is also increased too high so that the perpendicular bias magnetic field can not be applied to the free magnetization layer sufficiently. However, if the relation of MRH/MRT≦2.5 is satisfied, the above-described problem can not be caused.

In this embodiment, it is also desired that the sense current is flowed to the free magnetization layer 1340 from the fixed magnetization layer 1342. In this case, the ratio of electron with spin to invert the magnetization of the free magnetization layer 1340 and thus, cause the spin injecting magnetization inverse can be reduced. Therefore, the spin injecting magnetization inverse can be inhibited effectively in the magneto-resistance effect element 1100.

The bottom shield layer 1110 and the top shield layer 1140 are made of NiFe alloy and also function as a bottom electrode and a top electrode, respectively. The underlayer 1310 is made of Ta so as to enhance the exchange coupling between the antiferromagnetic layer 1320 and the ferromagnetic layer 1344, and the crystallinity of the spin valve film.

The antiferromagnetic layer 1320 is made of PtMn alloy, X-Mn (herein, X is at least one selected from the group consisting of Pd, Ir, Rh, Ru, Os, Ni, Fe) alloy or Pt—Mn—X′ (herein, X′ is at least one selected from the group consisting of Pd, Ir, Rh, Ru, Au, Ag, Os, Cr, Ni, Ar, Ne, Xe, Kr). In order to realize the large exchange coupling magnetic field, such an alloy as listed above is thermally treated.

The ferromagnetic layer 1344, the magnetic coupling layer 1343 and the fixed magnetization layer 1342 constitute so-called synthetic antiferromagnets (SyAFs), respectively. The ferromagnetic layer 1344 and the fixed magnetic layer 1342 may include, as base materials, materials containing at least one selected from the group consisting of Fe, Co, Ni, Mn, respectively. The ferromagnetic layer 1344 and/or the fixed magnetization layer 1342 are formed as a single-layered structure or a multilayered structure. With the multilayered structure, the CoFe alloy layer and the Cu layer may be stacked. The magnetic coupling layer 1343 may be made of non-magnetic metallic material such as Cu, Au, Ru, Rh, Ir.

The ferromagnetic layer 1344 is antiferromagnetically coupled with the fixed magnetization layer 1342 via the magnetic coupling layer 1343 so that the magnetization direction of the ferromagnetic layer 1344 is fixed by the antiferromagnetic layer 1320.

The intermediate layer 1341 may be made of non-magnetic metallic material with high electric conductivity such as Cu, Au. The intermediate layer 1341 may be also made of another material such as Mn, Re, Ru, Pd, Pt, Ag, Al, Sc, Zn, Ga, Ge, Zr, Hf, Y, Tc, In, Sn, Ca, Sr, Ba. The intermediate layer 1341 may be also made of a composite material where a conductor (Cu, Fe, Co, Ni, or alloy thereof) is provided in an insulator (Al₂O₃), which is listed in document No. 5.

The conductor is made of Mn, Re, Ru, Pd, Pt, Ag, Al, Sc, Zn, Ga, Ge, Zr, Hf, Y, Tc, In, Sn, Ca, Sr, Ba. The intermediate layer 1341 mainly functions as separating the magnetic coupling between the free magnetization layer and the fixed magnetization layer 1342.

[Document No. 5] JP-A 2005-109378 (KOKAI)

The free magnetization layer 1340 is made of, e.g., NiFe alloy or a multilayered film with NiFe alloy film and CoFe alloy film such that the magnetization of the free magnetization layer 1340 is varied in accordance with the direction of an external magnetic field. The protective film 1350 is made of, e.g, Cu, Ta, Ru, thereby protecting the spin valve film 1200 after the formation of the film 1200 in the fabricating process of the magneto-resistance effect element 1100.

The magnetic domain controlling films 1120 (which are preferably made of CoPt alloy or CoCrPt alloy) is formed on the insulating layers 1150 (which are preferably made of Al₂O₃ or AlN). As described above, the magnetic domain controlling films 1120 function as a perpendicular biasing mechanism to apply the perpendicular biasing magnetic field to the free magnetization layer 1340 under the condition that the direction of the perpendicular biasing magnetic field is almost parallel to the main surface of the magneto-resistance effect film and almost perpendicular to the magnetization of the fixed magnetization layer 1342.

In view of the practical use of the magneto-resistance effect element 1100, the bias point is preferably set within a fluctuating range of 20 to 80%. If the bias point is set too high or too low, the magneto-resistance effect element 1100 can not respond to the variation of the external signal magnetic field and some noises not anticipated in advance may occur. For example, the output of the magneto-resistance effect element 1100 can not be varied when the external signal magnetic field is varied to another direction from the initial direction. The bias point is more preferably set within a fluctuating range of 35 to 65%.

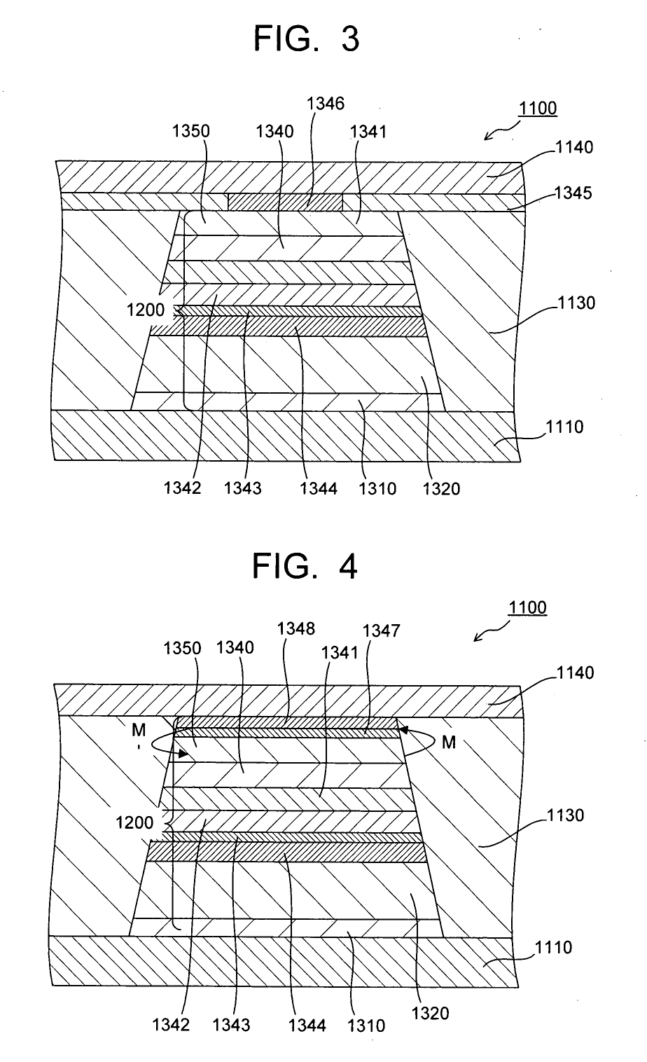

FIG. 3 is a cross sectional view illustrating another embodiment of the magneto-resistance effect element of the present invention. The magneto-resistance effect element 1100 in this embodiment is the same as the one illustrated in FIG. 1 except that the magnetic controlling films 1120 and the insulating layers 1150 are substituted with insulators 1130 and an exchange biasing Layer 1345 and a top electrode 1346 are provided between the protective film 1350 and the top shield layer 1140. The same reference numerals are imparted to corresponding or like components through FIGS. 1 to 3.

The exchange biasing layer 1345 is made of the same material as the antiferromagnetic layer 1320 such as PtMn alloy, X-Mn (herein, X is at least one selected from the group consisting of Pd, Ir, Rh, Ru, Os, Ni, Fe) alloy or Pt—Mn—X′ (herein, X is at least one selected from the group consisting of Pd, Ir, Rh, Ru, Au, Ag, Os, Cr, Ni, Ar, Ne, Xe, Kr). In this case, the exchange biasing layer 1345 functions as a perpendicular biasing mechanism to apply the perpendicular bias magnetic field to the free magnetization layer 1340 through exchange coupling under the condition that the direction of the biasing magnetic field is almost parallel to the main surface of each layer constituting the magneto-resistance effect element 1100 and almost perpendicular to the magnetization of the fixed magnetization layer 1342.

In this embodiment, a layer made of ferromagnetic material, soft magnetic material or non-magnetic material may be provided between the exchange biasing layer 1345 and the free magnetization layer 1350.

In this embodiment, since the magnetization of the fixed magnetization layer 1342 is oriented perpendicular to the space of the present specification, the width MRT almost parallel to the perpendicular bias magnetic field and the width MRH almost orthogonal to the perpendicular bias magnetic field and almost parallel to the signal magnetic field from the magnetic recording medium in the free magnetization layer 1340 correspond to the width and the depth of the free magnetization layer 1340 as schematically depicted in FIG. 2, respectively.

In this embodiment, the relation of MRH/MRT≧1.2 is satisfied. In this case, even though the MRT and MRH are set to not more than 100 nm, the spin injecting magnetization inverse does not almost depend on the bias point, so that the productive yield of the magneto-resistance effect element 1100 can be enhanced. Preferably, the relation of MRH/MRT≧1.5 is satisfied.

In this embodiment, it is desired that the relation of 1.2≦MRH/MRT≦2.5 is satisfied. If the value of MRH/MRT is set too high, the demagnetizing field in the MRT direction of the magneto-resistance effect element 1100 is also increased too high so that the perpendicular bias magnetic field can not be applied to the free magnetization layer sufficiently. However, if the relation of MRH/MRT≦2.5 is satisfied, the above-described problem can not be caused.

In this embodiment, it is also desired that the sense current is flowed to the free magnetization layer 1340 from the fixed magnetization layer 1342. In this case, the ratio of electron with spin to invert the magnetization of the free magnetization layer 1340 and thus, cause the spin injecting magnetization inverse can be reduced. Therefore, the spin injecting magnetization inverse can be inhibited effectively in the magneto-resistance effect element 1100.

The magnetic moment to cause the antiferromagnetic order in the exchange biasing layer 1345 is orthogonal to the magnetization of the fixed magnetization layer 1342. Therefore, if the relative angle between the magnetic moment in the exchange biasing layer 1345 and the magnetization of the fixed magnetization layer 1342 is shifted from 90 degrees (orthogonal angle), the bias point can be controlled.

In a modified embodiment according to the present invention, the magnetic domain controlling films are formed in addition to the exchange biasing layer 1345, thereby constituting the perpendicular biasing mechanism from the combination of the exchange biasing layer 1345 and the magnetic domain controlling films. In this case, if the magnetic moment of the exchange biasing layer 1345 is shifted, the bias point can be controlled.

The exchange biasing layer 1345 may be made of a material with a lower blocking temperature (which means a blocking temperature of an exchange coupling between a ferromagnetic layer and an antiferromagnetic layer) than the material to be used for the antiferromagnetic layer 1320. Typically, the antiferromagnetic layer 1320 may be made of PtMn and the exchange biasing layer 1345 may be made of IrMn. The exchange coupling magnetic field depends on the crystal particle distribution in a film and a degree of vacuum in the film-forming process. The exchange coupling magnetic field of a film made of PtMn is increased as the thickness of the film is increased, but the exchange coupling magnetic field of a film made of IrMn is decreased as the thickness of the film is increased.

The exchange coupling magnetic field can be caused by the thermal treatment of the magneto-resistance effect element 1100 containing the antiferromagnetic film. The thermal treatment is carried out by two steps. At the first step, the magneto-resistance effect element is thermally treated by applying an antiferromagnetic layer-thermally treating magnetic field. At the second step, the magneto-resistance effect element is thermally treated at a lower temperature than the first step by applying an exchange biasing layer-thermally treating magnetic field which is shifted from the antiferromagnetic layer-thermally treating magnetic field. Generally, the exchange biasing layer-thermally treating magnetic field is set orthogonal to the antiferromagnetic layer-thermally treating magnetic field. However, if the relative angle between the exchange biasing layer-thermally treating magnetic field and the antiferromagnetic layer-thermally treating magnetic field is shifted from 90 degrees (orthogonal angle), the bias point can be controlled.

FIG. 4 is a cross sectional view illustrating still another embodiment of the magneto-resistance effect element of the present invention. The magneto-resistance effect element 1100 in this embodiment is the same as the one illustrated in FIG. 3 except that the exchange biasing layer 1348 and the top electrode 1346 are substituted with an in-stack biasing layer 1348 made of hard magnetic material such as CoPt alloy or CoCrPt alloy) via a separating layer 1347. The same reference numerals are imparted to corresponding or like components through FIGS. 3 to 4.

In this embodiment, the separating layer 1347 and the in-stack biasing layer 1348 constitute the perpendicular biasing mechanism, thereby causing static magnetic couplings M and M′ between the edges of the in-stack biasing layer 1348 and the free magnetization layer 1350 so that the magnetization of the free magnetization layer is aligned parallel to the main surface of the magneto-resistance effect film and perpendicular to the magnetization of the fixed magnetization layer.

In this embodiment, since the magnetization of the fixed magnetization layer 1342 is oriented perpendicular to the space of the present specification, the width MRT almost parallel to the perpendicular bias magnetic field and the width MRH almost orthogonal to the perpendicular bias magnetic field and almost parallel to the signal magnetic field from the magnetic recording medium in the free magnetization layer 1340 correspond to the width and the depth of the free magnetization layer 1340 as schematically depicted in FIG. 2.

In this embodiment, the relation of MRH/MRT≧1.2 is satisfied. In this case, even though the MRT and MRH are set to not more than 100 nm, current induced magnetization switching does not almost depend on the bias point, so that the productive yield of the magneto-resistance effect element 1100 can be enhanced. Preferably, the relation of MRH/MRT≧1.5 is satisfied.

In this embodiment, it is desired that the relation of 1.2≦MRH/MRT≦2.5 is satisfied. If the value of MRH/MRT is set too high, the demagnetizing field in the MRT direction of the magneto-resistance effect element 1100 is also increased too high so that the perpendicular bias magnetic field can not be applied to the free magnetization layer sufficiently. However, if the relation of MRH/MRT≦2.5 is satisfied, the above-described problem can not be caused.

In this embodiment, it is also desired that the sense current is flowed to the free magnetization layer 1340 from the fixed magnetization layer 1342. In this case, the ratio of electron with spin to invert the magnetization of the free magnetization layer 1340 and thus, cause current induced magnetization switching can be reduced. Therefore, current induced magnetization switching can be inhibited effectively in the magneto-resistance effect element 1100.

The magnetic moment to cause the antiferromagnetic order in the in-stack biasing layer 1348 is orthogonal to the magnetization of the fixed magnetization layer 1342. Therefore, if the relative angle between the magnetic moment in the in-stack biasing layer 1348 and the magnetization of the fixed magnetization layer 1342 is shifted from 90 degrees (orthogonal angle), the bias point can be controlled.

In a modified embodiment according to the present invention, the magnetic domain controlling films are formed in addition to the in-stack biasing layer 1348, thereby constituting the perpendicular biasing mechanism from the combination of the in-stack biasing layer 1348 and the magnetic domain controlling films. In this case, if the magnetic moment of the in-stack biasing layer 1348 is shifted, the bias point can be controlled.

In those embodiments, if the magnetic thickness of the ferromagnetic layer is set different from the magnetic thickness of the fixed magnetization layer, thereby applying the thus obtained leak static magnetic field to the free magnetization layer, the bias point can be also controlled. The controlling method of bias point can be combined with the controlling method of bias point shifting the relative angle between the magnetization of the fixed magnetization layer 1342 and the magnetic moment in the exchange coupling layer 1345 or the in-stack biasing layer 1348.

The magnetic thickness can be varied by varying the inherent thickness of a layer, but may be varied by changing the composition of the layer. For example, if the layer is made of Co₈₀Fe₂₀ or Co instead of Co₉₀Fe₁₀, the magnetic thickness of the layer can be varied.

The bias point can be controlled by using the large interlayer coupling magnetic field between the free magnetization layer and the fixed magnetization layer. Normally, the magnetic thickness of the magnetic domain controlling films 1120 is around 3.0 memu/cm², but if the magnetic thickness is decreased to 1.5 memu/cm², the interlayer coupling magnetic field can be increased beyond 150 Oe.

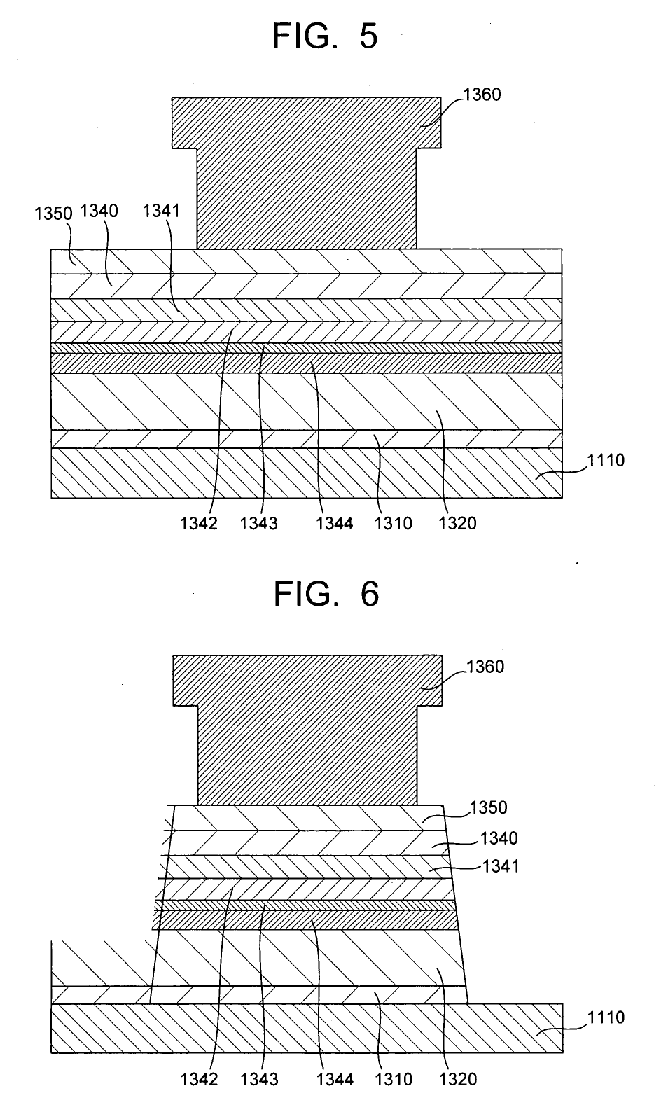

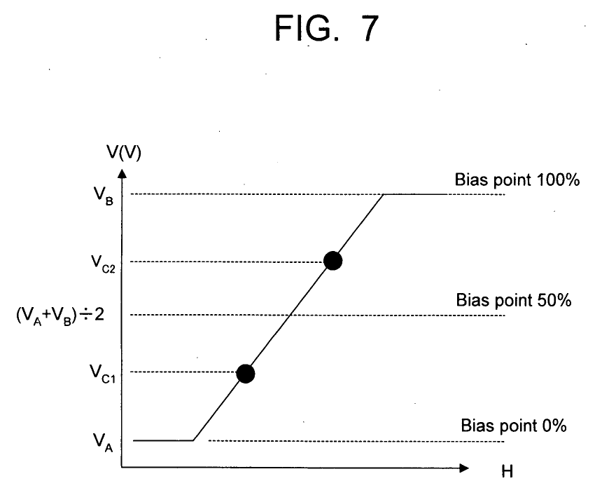

Then, the magneto-resistance effect element 1100 depicted in FIG. 1 will be described hereinafter. FIGS. 5 and 6 are explanatory views showing steps in the fabrication of the magneto-resistance effect element 1100.

First of all, as illustrated in FIG. 5, the bottom shield layer 1110, the under layer 1310, the antiferromagnetic layer 1320, the ferromagnetic layer 1344, the magnetic coupling layer 1343, the fixed magnetization layer 1342, the intermediate layer 1341, the free magnetization layer 1340 and the protective layer 1350 are subsequently formed on a base (not shown).

Each layer may be made by means of sputtering. As the sputtering may be employed DC magnetron sputtering, RF magnetron sputtering, ion-beam sputtering, long-slow sputtering, collimation sputtering or the combination thereof.

Then, a resist layer 1360 is formed on the protective layer 1350, and ion-milling is carried out for the laminated structure as depicted in FIG. 5 so that both edges of the laminated structure are etched to the underlayer 1310 from the protective layer 1350, as shown in FIG. 6. Then, the insulating layer 1150 and the magnetic domain controlling films 1120 are formed at the etched portions of the laminated structure. Then, the resist layer 1360 is removed, and the top shield layer 1140 is formed, thereby completing the magneto-resistance effect element 1100.

In this embodiment, with the magneto-resistance effect element 1100, the fixed magnetization layer, the intermediate layer, and the free magnetization layer are subsequently formed, thereby constituting a bottom type magneto-resistance effect element, but the free magnetization layer, the intermediate layer and the fixed magnetization layer are subsequently formed, thereby constituting a top type magneto-resistance effect element.

In the present specification, the bias point can be defined below. FIG. 7 is an explanatory view for the bias point in the magneto-resistance effect element of the present invention. In the drawing, the variation in output V of the magneto-resistance effect element v.s. the signal magnetic field H is represented as a graph, which is called as a “transfer curve”.

It is assumed that a lower signal voltage (preferably, several mV through 40 mV) is applied to the magneto-resistance effect element. The output from the magneto-resistance effect element becomes the lower value of VA when low signal magnetic field is applied because the magnetization direction of the fixed magnetization layer becomes nearly parallel to the magnetization direction of the free magnetization layer. In contrast, when high signal magnetic field is applied to the magneto-resistance effect element, the output from the magneto-resistance effect element becomes the higher value of VB because the magnetization direction of the fixed magnetization layer becomes nearly anti-parallel to the magnetization direction of the free magnetization layer. Moreover, when the signal magnetic field is set to zero, the output from the magneto-resistance effect element becomes an intermediate value Vc between the values VA and VB. Therefore, the bias point BP can be calculated by the following equation:

BP=(V_{C}−V_{A})/(V_{B}V_{A})×100(%)

Then, the resistance of the magneto-resistance effect element is defined as R_{A}, R_{C} and R_{B}, respectively as the intensity of the signal magnetic field is increased. In this case, the bias point BP can be calculated by the following equation:

BP=(R_{C}−R_{A})/(R_{B}−R_{A})×100(%)

The bias point can be defined by another method. For example, the variation in output voltage V or resistance R of the magneto-resistance effect element is measured by varying the sense current to be applied to the element under the constant signal magnetic field. Under the small sense current condition, whether the output from the magneto-resistance effect element at no signal magnetic field is adjacent to an output at a given positive signal magnetic field or a given negative signal magnetic field is inspected. When the given positive magnetic field is set to +400 Oe, the given negative magnetic field is set to −400 Oe. In this case, the intensity of the positive signal magnetic field is the same as the intensity of the negative signal magnetic field so that the direction of the positive signal magnetic field is opposite to the direction of the negative signal magnetic field. In this case, too, the bias point can be measured in the above-listed equations. In this bias point determining method, the bias point can be defined properly as the intensity of the signal magnetic field is increased. Preferably, the intensity of the signal magnetic field is set to 400 Oe or over.

Then, a magnetic recording/reproducing device, in which the magneto-resistance effect element of the present invention is installed, will be described. For example, the magneto-resistance effect element is installed in advance in an all-in-one magnetic head assembly allowing both the recording/reproducing, and mounted as the head assembly at the magnetic recording/reproducing device.

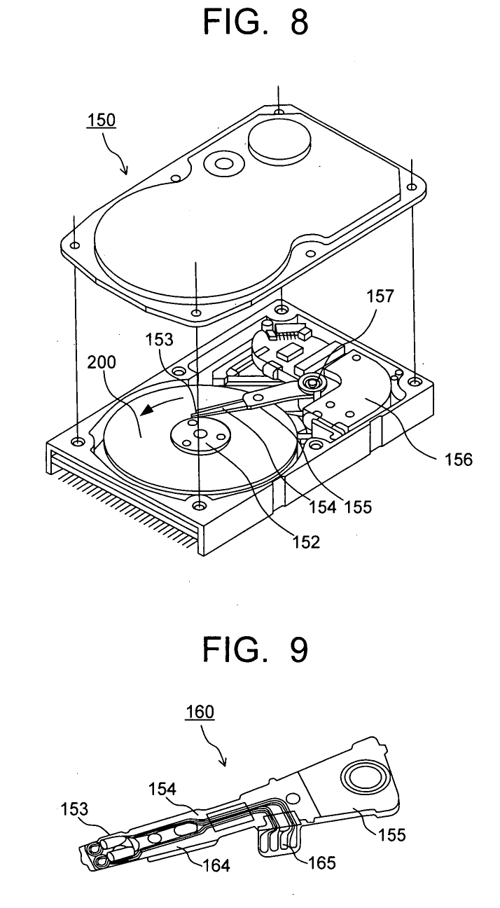

FIG. 8 is a perspective view illustrating the schematic structure of the magnetic recording/reproducing device. In FIG. 8, the essential components of the magnetic recording/reproducing device are illustrated. The magnetic recording/reproducing device 150 constitutes a rotary actuator type magnetic recording/reproducing device. In FIG. 8, a magnetic recording disk 200 is mounted to a spindle 152 to be turned in the direction designated by the arrow A by a motor (not shown) which is driven in response to control signals from a drive unit controller (not shown). The magnetic recording/reproducing apparatus 150 of the present invention may be that provided with a plurality of magnetic recording disks 200. Each magnetic recording disk 200 may constitute a longitudinal magnetic recording type magnetic disk wherein the magnetization direction of recorded bits is parallel to the main surface thereof or a perpendicular magnetic recording type magnetic disk wherein the magnetization direction of recorded bits is perpendicular to the main surface thereof.

A head slider 153 recording/reproducing information to be stored in the magnetic recording disk 200 is mounted on a tip of a suspension 154 of a thin film type. The head slider 153 mounts the magnetic resistance effect element as described in above embodiments or the magnetic head containing the magnetic resistance effect element.

When the magnetic recording disk 200 is rotated, such a surface (ABS) of the head slider 153 as being opposite to the magnetic recording disk 200 is floated from on the main surface of the magnetic recording disk 200. Alternatively, the slider may constitute a so-called “contact running type” slider such that the slider is in contact with the magnetic recording disk 200. The suspension 154 is connected to one edge of the actuator arm 155 with a bobbin portion supporting a driving coil (not shown) and the like. A voice coil motor 156 being a kind of a linear motor is provided at the other edge of the actuator arm 155. The voice coil motor 156 is composed of the driving coil wound around the bobbin portion and a magnetic circuit with a permanent magnet and a counter yoke which are disposed opposite to one another so as to sandwich the driving coil.

The actuator arm 155 is supported by ball bearings (not shown) provided at the upper portion and the lower portion of the spindle 157 so as to be rotated and slid freely by the voice coil motor 156.

FIG. 9 is an enlarged perspective view illustrating a portion of the magnetic head assembly positioned at the tip side thereof from the actuator arm 155, as viewed from the side of the magnetic recording disk 200. As illustrated in FIG. 9, the magnetic head assembly 160 has the actuator arm 155 with the bobbin portion supporting the driving coil and the like. The suspension 154 is connected with the one edge of the actuator arm 155. Then, the head slider 153 with the magneto-resistance effect element as defined in above-embodiments according to the present invention is attached to the tip of the suspension 154. The suspension 154 includes a lead wire 164 for writing/reading signals, wherein the lead wire 164 is electrically connected with the respective electrodes of the magnetic head embedded in the head slider 153. In the drawing, reference numeral “165” denotes an electrode pad of the assembly 160.

According to the magnetic recording/reproducing device of the present invention, since the magneto-resistance effect element is installed, the information magnetically recorded in the magnetic recording disk 200 can be read out properly.

### EXAMPLE

In this Example, a CPP type magneto-resistance effect element as illustrated in FIG. 1 was fabricated so that the relation between the current induced magnetization switching and the bias point in the element was examined.

The underlayer 1310 was made of a Ta film with a thickness of 5 nm, and the antiferromagnetic layer 1320 was made of a PtMn film with a thickness of 15 nm. The ferromagnetic layer 1344 was made of a Co₉₀Fe₁₀ film with a thickness of 3.4 nm, and the non-magnetic coupling layer 1343 was made of a Ru film with a thickness 0.85 nm. The fixed magnetization layer 1342 was made of a Fe₅₀Co₅₀ film with a thickness of 3 nm, and the intermediate layer 1341 was made of an Al₂O₃ film with a thickness of 5 nm. Some electric conducting paths made of Cu were formed through the Al₂O₃ film. The free magnetization layer 1340 was made of a multilayered film of Co₉₀Fe₁₀ 1 nm/Ni₈₃Fe₁₇ 3.5 nm, and the protective layer 1350 was made of a Cu film with a thickness of 5 nm. The perpendicular biasing mechanism was made of magnetic domain controlling films of CoCrPt alloy. The antiferromagnetic layer 1320 was magnetized almost perpendicular to the magnetization of the magnetic domain controlling films. Then, some transfer curves of the magneto-resistance effect element were measured when a sense current was flowed to the fixed magnetization layer from the free magnetization layer as the MRT and MRH were varied.

Hereinafter, the polarities of the sense current and the biasing voltage are defined as positive when the sense current is flowed to the fixed magnetization layer from the free magnetization layer.

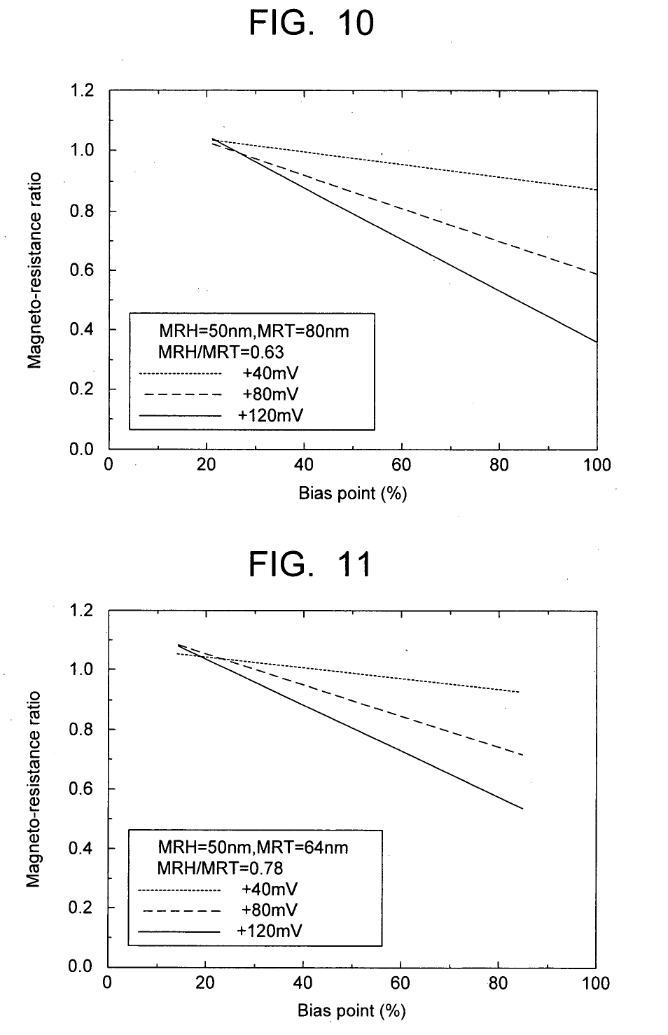

Then, the ratios of the magnetic resistance variation values at the biasing voltage being set to +40 mV, +80 mV and +120 mV to the magnetic resistance variation value at the biasing voltage being set to −40 mV were calculated so that the dependence of the bias point on the magnetic resistance variation ratio in the magneto-resistance effect element was measured. As a result, the bias point is intended to fluctuate almost within a range of 20 to 80%. In order to clarify the dependence of the bias point on the magnetic resistance variation ratio, 40 magneto-resistance effect elements with the same MRT and MRH as illustrated in FIG. 1 were fabricated so that the dependence of the bias point on the magnetic resistance variation ratio was measured by conducting linear fitting using a least squares method. The measured results are represented in FIGS. 10 to 13.

As is apparent from FIGS. 10 to 13, the bias point dependence on the magnetic resistance variation ratio is lowered as the MRT is increased and the MRT is decreased. Such tendencies as shown in FIGS. 10 to 13 become remarkable as the biasing voltage, that is, the amount of the transfer of the spin angular momentum is increased. Also, it is apparent that the magnet-resistance value is increased when the bias point is set within a range of 20 to 50%, which is desirable for the design of the intended magneto-resistance effect element.

Then, the magneto-resistance variation value averaged for the 40 magneto-resistance effect elements was calculated per MRH and MRT. As a result, when the MRH was set to 50 nm and the MRT was set to 80 nm (MRH/MRT=0.63), the averaged magneto-resistance variation value was 1.7%. When the MRH was set to 50 nm and the MRT was set to 64 nm (MRH/MRT=0.78), the averaged magneto-resistance variation value was 1.6%. When the MRH was set to 100 nm and the MRT was set to 83 nm (MRH/MRT=1.2), the averaged magneto-resistance variation value was 2.8%. When the MRH was set to 100 nm and the MRT was set to 64 nm (MRH/MRT=1.56), the averaged magneto-resistance variation value was 2.4%.

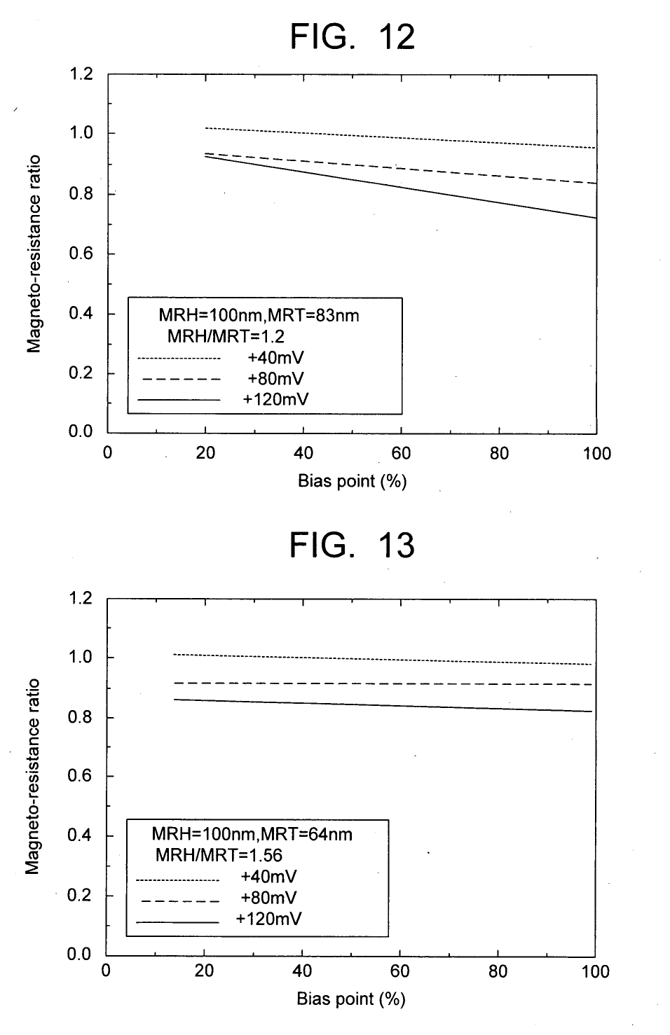

The reason the magneto-resistance variation value is decreased as the magneto-resistance effect element is downsized is that the indication KuV/K_{B}T (Ku: magnetic anisotropy constant, V: volume of magnetic material, K_{B}: Boltzmann constant, T: absolute temperature) to be used in the evaluation of magnetic thermal stability of a magnetic material is also decreased as the magneto-resistance effect element is downsized, so that the thermal stability of the magneto-resistance effect element is deteriorated. However, since the magneto-resistance effect elements relating to FIGS. 12 and 13 satisfy the requirements of the present invention, the magneto-resistance variation value becomes a relatively large value of 2% or over even though the magneto-resistance effect element is downsized.

In order to realize the high density recording in the magneto-resistance effect element, it is necessarily required that the MRT of the element corresponding to the track width of the magnetic recording medium is narrowed. Under the small MRT condition, if the MRH of the element is enlarged so that the MRH/MRT ratio is increased, the magneto-resistance variation value can be increased, which is favorable for the design of the magneto-resistance effect element.

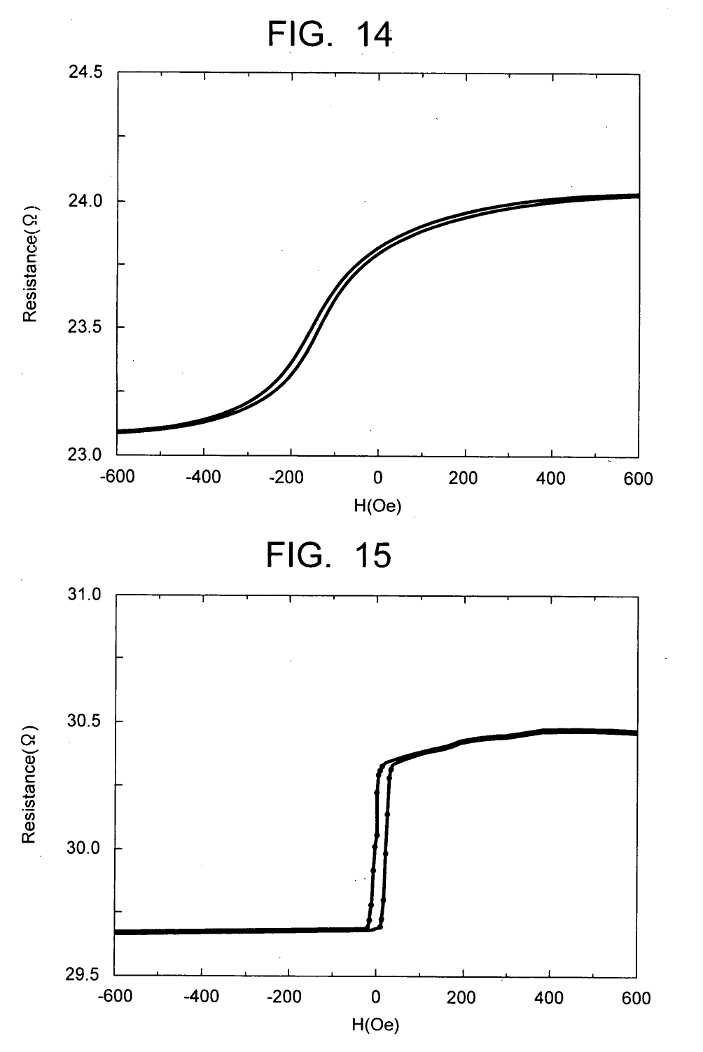

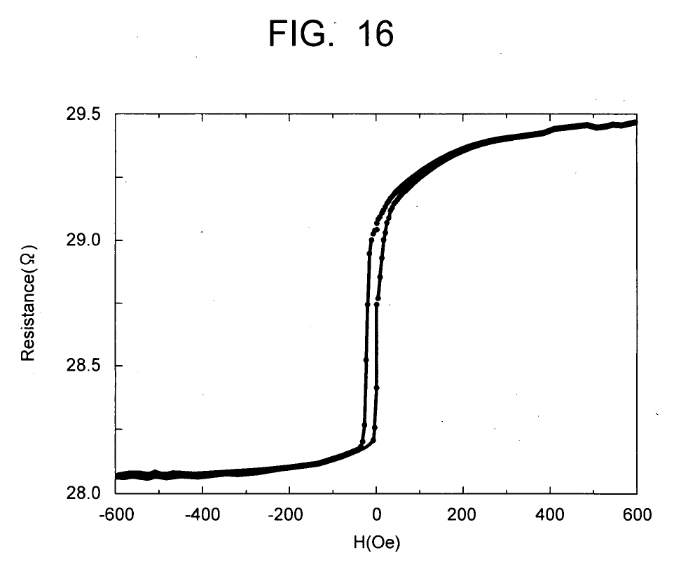

FIG. 14 is a graph showing the relation between the magneto-resistance R and the magnetic field in the CPP type magneto-resistance effect element when the MRT was set to 80 nm and the MRH was set to 200 nm (MRH/MRT=2.5). FIGS. 15 and 16 are also graphs showing the relation between the resistance R and the magnetic field in the CPP type magneto-resistance effect element when the MRT was set to 80 nm and the MRH was set to 250 nm (MRH/MRT=3.1). In these cases, the sense current is flowed to the fixed magnetization layer from the free magnetization layer.

As is apparent from FIG. 14, when the MRH/MRT is set to 2.5 or below, the variation of the magneto-resistance R of the magneto-resistance effect element for the signal magnetic field H forms a gradual curve so that the output of the magneto-resistance effect element is almost in proportion to the signal magnetic field H. As is apparent from FIGS. 15 and 16, in contrast, when the MRH/MRT is set beyond 2.5, the perpendicular biasing magnetic field can not be applied to the magneto-resistance effect element effectively so that the variation of the magneto-resistance R of the magneto-resistance effect element for the signal magnetic field H forms a stepwise curve. Therefore, the output of the magneto-resistance effect element is not in proportion to the signal magnetic field H. In this point of view, it is desired that the MRH/MRT is set to 2.5 or below.

Although the present invention was described in detail with reference to the above examples, this invention is not limited to the above disclosure and every kind of variation and modification may be made without departing from the scope of the present invention.

What is claimed is:

1. A magneto-resistance effect element, comprising:
a magneto-resistance effect film including a fixed magnetization layer of which a magnetization direction is fixed in one direction, a free magnetization layer of which a magnetization direction is varied in accordance with a signal magnetic field from a magnetic recording medium, and a non-magnetic intermediate layer representing metallic conduction which is provided between the free magnetization layer and the fixed magnetization layer;
a perpendicular biasing mechanism configured to apply a perpendicular biasing magnetic field to the free magnetization layer under the condition that the biasing magnetic field is parallel to a plane of the magneto-resistance effect film and perpendicular to the magnetization of the fixed magnetization layer; and
a pair of electrodes electrically connected to the magneto-resistance effect film so as to apply a current, flown from said fixed magnetization layer to said free magnetization layer;
wherein the relation of 1.2≦MRH/MRT is satisfied when in the free magnetization layer, in which MRT is a width being parallel to said perpendicular biasing magnetic field, and MRH is width being orthogonal to said perpendicular biasing magnetic field and being parallel to said signal magnetic field from said magnetic recording medium.

2. The magneto-resistance effect element as set forth in claim. 1,
wherein the relation of 1.2≦MRH/MRT≦2.5 is satisfied in said free free magnetization layer.

3. The magneto-resistance effect element as set forth in claim 1,
wherein said current is a sense current so as to be flowed to said free magnetization layer from said fixed magnetization layer.

4. The magneto-resistance effect element as set forth in claim 1,
wherein the bias point of said magneto-resistance effect element is set within a fluctuating range of 20 to 80%.

5. The magneto-resistance effect element as set forth in claim 1,
wherein said perpendicular biasing mechanism includes biasing layers made of hard magnetic material which are provided in contact at least with sides of said fixed magnetization layer.

6. The magneto-resistance effect element as set forth in claim 1,
wherein said perpendicular biasing mechanism includes a biasing layer which is provided on and magnetically connected with said fixed magnetization layer.

7. The magneto-resistance effect element as set forth in claim 6,
wherein said biasing layer is made of antiferromagnetic material and magnetically connected with said fixed magnetization layer through exchange coupling.

8. The magneto-resistance effect element as set forth in claim 6,
wherein said biasing layer is made of hard magnetic material and magnetostatically connected with said fixed magnetization layer.

9. A magneto-resistance effect head, comprising a magneto-resistance effect element as set forth in claim 1.

10. A magnetic recording/reproducing device, comprising a magneto-resistance effect head as set forth in claim 9 and a magnetic recording medium.

11. A magnetic memory, comprising a magneto-resistance effect element as set forth in claim 1.
